(19) United States
(12) Patent Application Publication
(10) Pub. No.: US 2026/0145470 A1
(43) Pub. Date: May 28, 2026

(54) RADIOFREQUENCY READING SYSTEM ON BOARD A TRANSPORT VEHICLE

(71) Applicant: COMPAGNIE GENERALE DES ETABLISSEMENTS MICHELIN, Clermont-Ferrand (FR)

(72) Inventors: JULIEN DESTRAVES, Clermont-Ferrand (FR); LAURENT COUTURIER, Clermont-Ferrand (FR)

(21) Appl. No.: 19/120,321

(22) PCT Filed: Oct. 12, 2023
(86) PCT No.: PCT/EP2023/078365

§ 371 Date: Apr. 11, 2025

(30) Foreign Application Priority Data
Oct. 14, 2022 (FR) FR2210566

(51) Int. Cl. B60C 23/06; B60C 23/04; H01Q 1/32; H01Q 13/20

(52) U.S. Cl. CPC B60C 23/068; B60C 23/0444; B60C 23/0452; H01Q 13/203; H01Q 1/3291

(57) ABSTRACT

A vehicle (2) equipped with a movable assembly (1) comprises a tire (12) set in rotation about an axis (102), the movable assembly (1) being equipped with a radiofrequency transponder (100) and a reading system (3) comprising: a generator coupled to a demodulator (31) of electrical signals; and a cable (32) galvanically connected to the generator (31), secured to the transport means (2) and comprising a radiating part (342) A projection R on a cylinder (104), with an axis of revolution (102), circumscribing the tire (12), of the radiating part is less than 1 meter, and the radiating part (342) comprises a meander (500) defined by a width “P” and a length “L”, the curvilinear length of the meander (500) being between 0.7 and 1.3 times the wavelength L0 associated with the communication frequency of the reading system (3).

### FIELD OF THE INVENTION

The present invention relates to a system for reading a radiofrequency transponder on board a transport vehicle. The radiofrequency transponders are mainly linked to the movable assemblies of the transport vehicle.

### TECHNOLOGICAL BACKGROUND

The recent development of connected objects requires them to be equipped with radiofrequency transponders. These radiofrequency transponders generally operate in the UHF (Ultra-High Frequency) frequency range, in other words between 300 MHz and 3 GHz. In the case of transport vehicles such as vehicles with tyres, the connected objects are movable components of these transport vehicles. As a result, they are movable in operation, moving in a plane about an axis of rotation that is fixed in relation to the transport vehicle. Therefore, in a reference frame linked to the transport vehicle, said transponders move in loops closed on themselves.

Document US20210021015A1 presents, in the case of a land vehicle, the installation of an on-board reading system for RFID (RadioFrequency IDentification) tags and TMS (Tyre Mounted Sensor) sensors located in the tyre casings of the mounted assemblies of the land vehicle. This system is formed of a radiofrequency reader/transmitter galvanically connected to four transmission lines as far as radiofrequency antennas each covering a certain geographical area. The radiofrequency antennas are rigidly secured to the fixed part of the land vehicle. This solution requires multiple radiofrequency antennas, which are generally two-dimensional and flat, or even three-dimensional. This creates a spatial footprint within the land vehicle that is detrimental to the installation of the other land vehicle components. In addition, the separation of the various elements (the radiofrequency reader, the transmission line and the radiofrequency antenna) multiplies the number of connection points between the various elements, which in turn multiplies the risk of failure of the reading system due to the vibration and shocks to which transport means are generally subjected. Lastly, the multitude of assemblies mounted on a land vehicle means that there are multiple transmission lines and radiofrequency antennas, which is costly.

One of the objects of the following invention is to solve the problems of reliability and cost of systems for reading movable radiofrequency transponders in transport vehicles.

In order to gain a better understanding of the invention, the circumferential direction S, axial direction A and radial direction R are directions defined with respect to the rotating frame of reference of the movable assembly about its natural axis of rotation. The radial direction R is the direction extending perpendicularly away from the natural axis of rotation. The axial direction A is the direction parallel to the natural axis of rotation. Finally, the circumferential direction S forms a direct trihedron with the predefined radial and axial directions.

### DESCRIPTION OF THE INVENTION

The invention relates to a transport vehicle comprising a radiofrequency transponder reading system and at least one movable assembly capable of ensuring the movement of the transport vehicle relative the ground over which the transport vehicle is travelling, comprising a tyre set in motion about an axis of rotation, the free movement of the at least one movable assembly taking place in a predominantly two-dimensional plane in a cylindrical reference frame associated with the at least one movable assembly, the axial direction of which is the direction of the axis of rotation, the tyre defining a median plane which is perpendicular to the axis of rotation, the at least one movable assembly, preferably the tyre, being equipped with a radiofrequency transponder. The reading system comprises:
a generator of electrical signals transmitting at a frequency F0 included in the ultra-high frequency band, coupled to a demodulator of electrical signals adapted to a frequency band around F0, mounted on the transport vehicle;
at least one bidirectional communication cable, partially flexible, comprising a conductive core covered with a first dielectric element, itself covered with a conductive assembly, having one end galvanically connected to the reading system, having at its free end a means for capacitive coupling between the conductive core and the conductive assembly via a second dielectric element, adapted to the frequency band of the reading system, the length l0 of which is divided according to a metric of which the unit is a wavelength L0 defined by the frequency F0;
the at least one bidirectional communication cable, being rigidly secured to the transport vehicle and external to the at least one movable assembly, comprises a radiating part.

The vehicle is characterized in that the distance of the radial projection of a first continuous part of the radiating part of the at least one cable on a cylinder, with an axis of revolution coaxial with the axis of rotation, circumscribing the tyre, is less than or equal to 1 metre, preferably less than or equal to 0.5 metre, in that the distance of the axial projection, in the direction of the axis of rotation, of the first continuous part of the radiating part of the at least one cable on the median plane of the tyre is less than 2 metres, preferably less than or equal to 1 metre, very preferably less than or equal to 0.5 metre, in that the first continuous part of the radiating part of the at least one cable comprises at least one meander comprising an outward path and a return path spaced apart from one another by a distance “P”, each outward path and return path extending over a length “L”, in that the curvilinear length of the at least one meander is between 0.7 and 1.3 times the wavelength L0 defined by the communication frequency F0 modulo the wavelength L0 and in that the distance “P” is less than a third of the wavelength L0, preferably the length “L” of the meander is less than or equal to the half-wavelength L0.

The term “free movement” means that the movement is carried out without displacement constraint as in the case of an imposed displacement movement. For example, in the case of a statically-loaded mounted assembly set in rotation, this refers to the movement of the material points of the mounted assembly outside the zone of contact of the tyre casing with the ground, commonly known as the contact area. To be specific, in this zone, the movement of a material point of the tyre casing in contact with the ground is guided by the ground as long as the sliding condition is not reached; thus, imposed displacement is achieved, which does not fall within the definition of free movement.

First, the movable assembly is the subassembly of the transport vehicle used to move the transport vehicle relative to the ground. The movable assembly comprises a tyre driven in rotation about an axis of rotation by non-deformable components, in other words components that are more rigid than the tyre, such as, for example, a rim.

The radiofrequency transponder may be an RFID tag or another electronic device with its own power source, or passive. The radiofrequency transponder is attached to the movable assembly of the transport vehicle. It may be for example an RFID tag in a tyre casing, a TPMS (Tyre Pressure Monitoring System) sensor attached to the wheel, or any electronic object communicating by radiofrequency and equipped with a radiofrequency antenna located on a movable assembly. In order to read this electronic object, which is linked to the movable assembly and therefore in motion in the transport vehicle, the invention discloses placing a reading system on board the transport vehicle, outside the movable assembly. As a result, it is not linked to the movement of the movable assembly. This reading system comprises a first device comprising a transmitter/receiver of electrical signals at a fixed frequency and a demodulator of electrical signals in a frequency band around the fixed frequency. This first device is connected to a bidirectional communication cable. This cable is composed of a conductive core, which is hollow or solid, generally metal, and a second conductive hollow tube coaxial with the conductive core. A first dielectric element separates the two conductive components. One end of the cable is connected to the transmitting/receiving electronic device, while the other end is free. This cable comprises at least one radiating part, i.e. it functionally transmits or receives radio waves externally to the hollow conductive tube. The cable is equipped at its free end with a means for capacitive coupling between the conductive core and the conductive assembly consisting of the conductive hollow tube, via a second dielectric element, adapted to the frequency band of the reading system.

This type of bidirectional communication cable uses surface radio waves via this capacitive coupling means. This makes it possible to have a bidirectional cable with no specificities on its surface on the radiating part. Thus, in the case where the cable is significantly deformed when it is installed in the transport vehicle, the communication functionality of the cable is not affected, as could be the case with a leaky feed antenna, in which the distribution and shapes of the holes passing through the conductive tube are more sensitive to deformation of the bidirectional cable. Furthermore, this technical solution is more economical, since it is considerably more expensive to produce the holes on the conductive tube than to place a device for electrical reflection by capacitive coupling at the end of a coaxial cable.

This type of cable is described in patent application US2016/0197408A1, comprising at its free end a device for electrical reflection by capacitive coupling, consisting of a conductive component connected to the conductive core and optionally separated from the conductive tube by a second dielectric material generating capacitive coupling. The length of the conductive component is generally a quarter of the wavelength of the radio waves transmitted and received by the cable antenna. This device creates surface propagation radio waves on the conductive tube in the direction opposite to that transmitted by the signal generator, up to a surface wave attenuation zone created by magnetized rings, generally made of ferrite, mounted axially outside the cable.

The invention is based first and foremost on the particular arrangement of the reading system and, in particular, of the radiating part of the bidirectional communication cable in relation to the path followed by the radiofrequency transponder driven in motion by the movable assembly. To be specific, the spatial distance between the radiating part of the cable and the radiofrequency transponder must be less than a certain distance, preferably one metre, during part of the loop described by the radiofrequency transponder as the movable assembly travels, so that radiofrequency communication can be established between the reading system and the radiofrequency transponder. This is ensured by two conditions linked to the structure of the movable assembly. To be specific, since the movable assembly has a primarily two-dimensional movement, in the reference frame linked to the movable assembly, outside the zones of imposed displacement, it is possible to define a median plane for the tyre of the movable assembly, which has the property of being perpendicular to the axis of rotation of the movable assembly and of separating the movable assembly into two symmetrical parts with respect to the median plane. The term “primarily bidirectional movement” means that the distance covered by a material point of the movable assembly between two instants, decomposed on an orthonormal reference frame linked to the movable assembly, has one component smaller than the other two. Generally speaking, this component is the one carried by the direction of the axis of rotation of the movable assembly. The first condition is that a continuous sub-part of the radiating part of the communication cable is no further than 2 metres from the median plane attached to the tyre of the movable assembly in the direction of the axis of rotation of the movable assembly. Naturally, the smaller the distance between the continuous part of the radiating part of the cable and the radiofrequency transponder, the better the radiofrequency communication between the two radiofrequency devices.

Then, since the tyre of the movable assembly is driven by a purely rotational movement about its axis of rotation, it is necessary to control the distance between the continuous part of the radiating part of the bidirectional communication cable and the tyre of the movable assembly. To this end, a second projection condition must be fulfilled. This condition, as regards the zone of the tyre in rotation about its axis of rotation, consists in defining the maximum distance of radial projection R of the continuous part of the radiating part of the bidirectional communication cable on the closest surface of the tyre of the movable assembly, which corresponds to the radially external surface of the tyre relative to its axis of rotation.

When these conditions are met during a part of the loop described as the radiofrequency transponder attached to the movable assembly travels, it is ensured that the continuous part of the radiating part of the bidirectional communication cable is potentially in bidirectional communication with the radiofrequency transponder on this part of the loop, and, moreover, this communication is spatially periodic since it is repeated on each loop. Naturally, the larger this part of the loop, the better the communication between the two components in terms of time. Preferably, the condition is met over the entire loop describing the path of the radiofrequency transponder.

Lastly, it is necessary that the continuous part of the radiating part of the bidirectional communication cable which is in this spatial zone with respect to the movable assembly comprise at least one meander. The meander is defined by a width denoted “P” and a length denoted “L”. The length “L” is defined relative to the axial direction of the radiating part of the cable outside the meander zones. One end of the length “L” begins at the change in curvature of the cable initiating the meander. The other end is defined by the point of the meander that is furthest away, in other words that has the greatest orthogonal projection, relative to the axial direction of the cable. The width “P” of the meander is defined using each axial average, in the direction of the cable, of the points of the meander defining the outward or return path of the meander, in other words all the points of the cable located between the two ends defining the length “L” of the meander on the outward or return path of the meander. The distance between these two axial averages, in the axial direction of the cable, determines the width “P” of the meander. This meander makes it possible to create a zone of enhanced communication between the bidirectional communication cable and the transponder in a mode of communication of radiofrequency transmission from the reading system, i.e. triggered by the reading system. This makes it possible to establish communication with the radiofrequency transponder, in particular when it is passive, by providing a sufficient quantity of energy for it to wake up and establish communication when the radiofrequency transponder is close to this meander in the course of its travel associated with the movement of the movable assembly. To be specific, this meander makes it possible to create an extensive spatial zone, proportional to the length “L” of the meander, in which the electric field E generated by the radiating part of the communication cable is stable and higher in amplitude than that generated outside the meander. This increase in the electric field E at the meander is only possible because of the arrangement between the outward path and the return path of the meander which creates a gap, that is to say a system with two oppositely charged armatures such as a capacitor, when the curvilinear length of the meander is close to the wavelength L0 associated with the communication frequency F0 of the reading system. The increase in the amplitude of the electric field E affords an increase in radiofrequency energy toward the radiofrequency transponder which allows it to be activated in communication mode. In the case of a passive radiofrequency transponder such as a passive RFID tag, the energy captured by the radiofrequency transponder is used to transmit the return radiofrequency message from the radiofrequency transponder. During the phase of reception of the radiofrequency message coming from the radiofrequency transponder, the linear radiating part of the communication cable is sufficient to pick up the return message as long as the distance between the two elements remains reasonable. Therefore, this meander is mainly to be used in zones where communication with the radiofrequency transponder is difficult, for example, when it is desired to interrogate a radiofrequency transponder that is spatially distant from the radiating part of the communication cable or when the environment of the vehicle or of the movable assembly is not favourable to radiofrequency communication owing, for example, to electrically conductive elements. Thus, a radiofrequency transponder located both on the outside of the tyre and on the outside of the transport vehicle, only the positioning of the radiating part of the cable radially outside the tyre is possible. However, the crown of the tyre, the radially outermost part of the tyre relative to its axis of rotation, comprises a metallic crown, often of radial design, which is detrimental to radiofrequency communication. In these specific cases, the presence of a meander still makes it possible to interrogate the radiofrequency transponder of the movable assembly and to receive its radiofrequency response via the first continuous part of the radiating part of the communication cable.

Moreover, it is preferable that the continuous part of the radiating part of the bidirectional communication cable which is in the spatial zone around the movable assembly have a curvilinear length greater than one unit of cable length. The unit of cable length is defined by the wavelength L0 associated with the frequency F0 of transmission of the radio signal by the reading system propagating in a medium of given relative dielectric permittivity. This ensures that the length of the antenna in the spatial zone delimited by one of the two geometric conditions is suitable for transmitting and receiving radio signals to and from the radiofrequency transponder attached to the movable assembly. Of course, the greater the length of the continuous part of the radiating part of the bidirectional communication cable, the better the communication between the reading system and the radiofrequency transponder.

According to a specific embodiment, the radiating part of the at least one cable comprising at least one second continuous part that is separate from the first continuous part, the distance of the radial projection of the at least one second continuous part of the radiating part of the at least one cable on a cylinder, of axis of revolution coaxial with the axis of rotation of the at least one second movable assembly, circumscribing the tyre of the at least one second movable assembly, is less than or equal to 1 metre, preferably less than 0.5 metre, and the distance of the axial projection, in the direction of the axis of rotation of the at least one second movable assembly, of the at least one second continuous part of the radiating part of the at least one cable on the median plane of the tyre of the at least one second movable assembly is less than 2 metres, preferably less than 1 metre, very preferably less than 0.5 metre.

This is a configuration where the bidirectional communication cable is able to interrogate movable assemblies of the same transport vehicle that are so far apart that the same continuous part of the radiating part of the communication cable cannot interrogate both movable assemblies. The conventional solution would then be to add a second bidirectional communication cable and position a continuous part of the radiating part of this second cable in the appropriate geographical area of the second movable assembly, which is costly. The solution here is to use the same bidirectional communication cable, which limits the number of galvanic connections to the electrical signal transmitter/receiver of the reading system. This cable is then equipped with a second continuous radiating part that is separate from the first continuous part. However, it may be the same radiating part of the cable. In this way, the same cable interrogates and receives information from each radiofrequency transponder associated with a different movable assembly in each case. To create an extensive radiating spatial zone, the radiating part of the cable must simply be passed over the same spatial zone several times to create a continuous zone. This creates an extensive radiating zone, allowing easy communication with the transponders of the transport vehicle passing through the spatial zone. Of course, it is possible to create several extensive radiating spatial zones, separate from one another, using this technique. Between these spatial zones, the cable has a lesser radiating behaviour, which nonetheless allows the transmission of radio signals along the cable to the reader. It is, of course, possible to increase the number of continuous and radiating parts along the length of the communication cable in order to communicate with several movable assemblies that are geographically distant from one another, to communicate with all the radiofrequency transponders of the transport vehicle, whether or not these are linked to a movable assembly of the transport vehicle. Similarly, a continuous part of the radiating part of the bidirectional communication cable can communicate with different movable assemblies as long as they are located at the right distance from the continuous part of the radiating part of the cable.

In a specific embodiment, in the radiating part of the cable, the conductive assembly is covered by a second conductive assembly which is connected to ground.

This limits the electromagnetic radiation coming from the cable in the transport vehicle, which may be necessary depending on the desired electromagnetic compatibility of the transport vehicle.

According to a particular embodiment, the at least one second continuous part of the radiating part of the at least one cable comprises at least one meander comprising an outward path and a return path spaced apart from one another by a distance “P”, each outward path and return path extending over a length “L”, the curvilinear length of the at least one meander is between 0.7 and 1.3 times the wavelength L0 defined by the communication frequency F0 modulo the wavelength L0, the distance “P” is less than a third of the wavelength L0, preferably the length “L” of the meander is less than or equal to the half-wavelength L0.

It is preferable that the second continuous part of the radiating part of the bidirectional communication cable which is close to a movable assembly comprise at least one meander. The meander is defined by a width denoted “P” and a length denoted “L”. The length “L” is defined relative to the axial direction of the radiating part of the cable outside the meander zones, said cable being in the zone defined by the radial projection and the axial projection of the cable on the movable assembly. One end of the length “L” begins at the change in curvature of the cable initiating the meander. The other end is defined by the point of the meander that is furthest away, in other words that has the greatest orthogonal projection, relative to the axial direction of the cable. The width “P” of the meander is defined using each axial average, in the direction of the cable, of the points of the meander defining the outward or return path of the meander, in other words all the points of the cable located between the two ends defining the length “L” of the meander on the outward or return path of the meander. The distance between these two axial averages, in the axial direction of the cable, determines the width “P” of the meander. This meander makes it possible to create a zone of enhanced communication between the bidirectional communication cable and the transponder in a mode of communication of radiofrequency transmission from the reading system, i.e. triggered by the reading system. This makes it possible to establish communication with the radiofrequency transponder, in particular when it is passive, by providing a sufficient quantity of energy for it to wake up and establish communication when the radiofrequency transponder is close to this meander in the course of its travel associated with the movement of the second movable assembly. To be specific, this meander makes it possible to create an extensive spatial zone, proportional to the length “L” of the meander, in which the electric field E generated by the radiating part of the communication cable is stable and higher in amplitude than that generated outside the meander. This increase in the electric field E at the meander is only possible because of the arrangement between the outward path and the return path of the meander which creates a gap, that is to say a system with two oppositely charged armatures such as a capacitor, when the curvilinear length of the meander is close to the wavelength L0 associated with the communication frequency F0 of the reading system. The increase in the amplitude of the electric field E affords an increase in radiofrequency energy toward the radiofrequency transponder which allows it to be activated in communication mode. In the case of a passive radiofrequency transponder such as an RFID tag, the energy captured by the radiofrequency transponder is used to transmit the return radiofrequency message from the radiofrequency transponder. During the phase of reception of the radiofrequency message coming from the radiofrequency transponder, the linear radiating part of the communication cable is sufficient to pick up the return message as long as the distance between the two elements remains reasonable. Therefore, this meander is mainly to be used in zones where communication with the radiofrequency transponder is difficult, for example, when it is desired to interrogate a radiofrequency transponder that is spatially distant from the radiating part of the communication cable or when the environment of the vehicle or of the movable assembly is not favorable to radiofrequency communication owing, for example, to electrically conductive elements. In these specific cases, the presence of a meander still makes it possible to interrogate the radiofrequency transponder of the movable assembly and to receive its radiofrequency response via the second continuous part of the radiating part of the communication cable.

Moreover, it is preferable that the continuous part of the radiating part of the bidirectional communication cable which is in the spatial zone around the second movable assembly have a curvilinear length greater than one unit of cable length. The unit of cable length is defined by the wavelength associated with the frequency F0 of transmission of the radio signal by the reading system propagating in a medium of given relative dielectric permittivity. This ensures that the length of the antenna in the spatial zone delimited by one of the two geometric conditions is suitable for transmitting and receiving radio signals to and from the radiofrequency transponder attached to the movable assembly. Of course, the greater the length of the continuous part of the radiating part of the bidirectional communication cable, the better the communication between the reading system and the radiofrequency transponder.

According to an advantageous embodiment, the radiating part of the at least one cable comprises at most 5 meanders, preferably at most 3 meanders.

Increasing the number of meanders limits the radiating nature of the cable outside the zones where the meanders are located, which can be detrimental to the interrogation of the radiofrequency transponders of the transport vehicle that are not located, during their movement, in the spatial zones of the continuous parts of the radiating part of the communication cable. An alternative for compensating for this low radiation of transmission from the cable is to increase the electrical power of the reading system. However, at the same power supplied to the reading system, it is preferable to limit the number of meanders to ensure sufficient radiofrequency communication over the entire length of the radiating part of the bidirectional communication cable.

According to another advantageous embodiment, each continuous part of the radiating part of the at least one cable comprises at most 3 meanders, preferably at most 2 meanders.

According to this same logic of uniformity of the communication capacity of the cable, it is preferable that each continuous part of the radiating part of the cable have no more than 3 meanders and very preferably no more than 2. Thus, the radiation power is distributed across the various continuous parts if there are several of them. In addition, radio transmission power is left in areas without meanders, the radiofrequency antenna of the radiofrequency transponder associated with the at least one movable assembly comprising at least one wire strand defining a first longitudinal axis, each meander of the first and/or the at least one second continuous part of the radiating part of the at least one cable defining a median line defined by the direction of the length “L” of the at least one meander, the angle formed by the direction vectors of the first longitudinal axis and the median line is between 60 and 120 degrees, preferably between 80 and 100 degrees, over at least part of the closed path described by at least one movable assembly.

According to a specific embodiment, the radiofrequency transponder associated with the at least one movable assembly comprising a radiofrequency antenna comprising at least one wire strand defining a first longitudinal axis, each meander of the first and/or the at least one second continuous part of the radiating part of the at least one cable defining a median line defined by the direction of the length “L” of the at least one meander, the angle formed by the direction vectors of the first longitudinal axis and the median line is between 60 and 120 degrees, preferably between 80 and 100 degrees, over at least part of the closed path described by the at least one movable assembly.

In the particular case where the radiofrequency transponder is equipped with a wire antenna, it is necessary that the directions of the first longitudinal axis and the direction of the median line be substantially perpendicular to one another in order to ensure electromagnetic coupling between the radiofrequency transponder and the meander. To be specific, the electric field E generated by the meander is primarily perpendicular to the direction of the median line defined by the meander. Therefore, the wire antenna of the transponder is aligned substantially with the electric field E generated by the meander. Ideally, the wire antenna should be collinear with the electric field E of the meander for maximum coupling efficacy. However, the level of communication between the two antennas is entirely adequate as long as the angle formed by the two directions does not diverge by more than 30 degrees. This is preferable when the radiofrequency transponder is passive, i.e. without its own source or production of electrical energy. In this case, the electromagnetic coupling serves to activate the radiofrequency transponder by transmitting energy to it before it transmits.

Of course, since the radiofrequency transponder is in motion whereas the reading system is fixed relative to the transport vehicle, the angular condition is not necessarily met over the entire path described by the radiofrequency transponder. However, it is sufficient for the angular condition to be met over part of the path taken by the movable assembly for radiofrequency communication between the two electronic systems to be effective.

According to a first very specific embodiment, with the at least one movable assembly being capable of describing a rotational movement about a single axis of rotation defining a cylindrical reference frame about this axis of rotation, the first longitudinal axis of the radiofrequency antenna of the radiofrequency transponder associated with the at least one movable assembly having its main component oriented circumferentially in the cylindrical reference frame, and the at least one meander associated with the first and/or the at least one second continuous part of the radiating part of the at least one cable being arranged radially outside the movable assembly relative to the axis of rotation, the median line of the at least one meander has its main component oriented axially in the cylindrical reference frame of the movable assembly.

When the first longitudinal axis of the radiofrequency transponder of the movable assembly is mainly circumferential in the cylindrical reference frame of the mounted assembly, as may be the case with RFID tags embedded in the structure of the tyre in the sidewall or in the lower zone, and when the meander is located radially outside the tyre relative to the axis of rotation of the movable assembly, it is advisable to position the meander such that the median line has a predominantly axial direction in the cylindrical reference frame of the movable assembly. Therefore, it is certain that during the rotational movement of the movable assembly, the directions of the first longitudinal axis of the wire antenna of the radiofrequency transponder and of the electric field generated by the meander are aligned substantially with a part of the loop described by the movement of the radiofrequency transponder.

Very specifically to this first specific embodiment, with the radiofrequency antenna of the radiofrequency transponder associated with the at least one movable assembly and the at least one meander associated with the first and/or the at least one second continuous part of the radiating part of the cable projecting in the same circumferential plane, the projection of the antenna is entirely included in the projection of the at least one meander.

In the case where the radiofrequency transponder of the movable assembly is embedded in the rubber compounds of the tyre as may be the case with an RFID tag, the size of the radiofrequency antenna of the radiofrequency transponder, defined by the wire strand(s) and being linked to the radiocommunication frequency F0 of the radiofrequency transponder, is small owing to the relative dielectric permittivity of the rubber compounds of the tyre. To be specific, the relative dielectric permittivity of rubber compounds is different from that of air, which modifies the wavelength of radio waves. In this case, depending on the communication frequency F0, it is possible that the size of the radiofrequency antenna will be smaller than the distance “P” between the outward path and the return path of the meander. It is thus possible that the entire radiating antenna of the transponder will be positioned in the electric field E generated by the meander, which increases the communication power of the radiofrequency transponder.

According to a second very specific embodiment, with the movable assembly being capable of describing a rotational movement about a single axis of rotation defining a cylindrical reference frame about this axis of rotation, the first longitudinal axis of the radiofrequency antenna of the radiofrequency transponder associated with the at least one movable assembly having its main component oriented circumferentially in the cylindrical reference frame, and the at least one meander associated with the first and/or the at least one second continuous part of the radiating part of the cable being arranged axially outside and radially inside the movable assembly relative to the axis of rotation, the median line of the at least one meander has its main component oriented radially in the cylindrical reference frame of the movable assembly.

When the first longitudinal axis of the radiofrequency transponder of the movable assembly is mainly circumferential in the cylindrical reference frame of the mounted assembly, as may be the case with RFID tags embedded in the structure of the tyre in the sidewall or in the lower zone, and when the continuous part of the radiating part of the communication cable is located axially outside and radially inside the tyre relative to the axis of rotation of the movable assembly, it is advisable to position the meander such that the median line has a predominantly radial direction in the cylindrical reference frame of the movable assembly. Therefore, it is certain that during the rotational movement of the movable assembly, the directions of the first longitudinal axis of the wire antenna of the radiofrequency transponder and of the electric field generated by the meander are aligned substantially with a part of the loop described by the movement of the radiofrequency transponder.

Very specifically to this second specific embodiment, with the radiofrequency antenna of the radiofrequency transponder associated with the at least one movable assembly and the at least one meander associated with the first and/or the at least one second continuous part of the radiating part of the cable projecting in the same axial plane, the projection of the antenna is entirely included in the projection of the at least one meander.

In the case where the radiofrequency transponder of the movable assembly is embedded in the rubber compounds of the tyre as may be the case with an RFID tag, the size of the radiofrequency antenna of the radiofrequency transponder, defined by the wire strand(s) and being linked to the radiocommunication frequency F0 of the radiofrequency transponder, is small owing to the relative dielectric permittivity of the rubber compounds of the tyre. To be specific, the relative dielectric permittivity of rubber compounds is different from that of air, which modifies the wavelength of radio waves. In this case for example, depending on the communication frequency F0, it is possible that the size of the radiofrequency antenna will be smaller than the distance “P” between the outward path and the return path of the meander. It is thus possible that the entire radiating antenna of the transponder will be positioned in the electric field E generated by the meander, which increases the communication power of the radiofrequency transponder.

Advantageously, the radiofrequency transponder comprises an RFID tag.

This is a particular embodiment in which the radiofrequency transponder comprises an RFID (RadioFrequency IDentification) tag. This is small in size since it requires few components to operate, which allows it to be installed actually inside the tyre of the movable assembly or on its external surface by means of a specific connection patch. The primary function of such an electronic system is to convey identification information, usually encoded in the non-erasable memory of the electronic system. In a specific embodiment, the RFID tag is passive, without its own power source. In this particular case, the RFID tag interrogation phase consists first of transferring radiofrequency energy to it to become operational and then respond to its interrogation.

Advantageously, with the movable assembly being capable of describing a rotational movement about an axis of rotation, each continuous part of the at least one cable describes an angular sector about the axis of rotation which is at least greater than 30 degrees, preferably greater than 60 degrees, very preferably greater than 120 degrees.

In the case of a movable assembly rotating about a single axis of rotation, it is preferable that, in a rotating reference frame associated with the single axis of rotation, the continuous part of the radiating part of the bidirectional communication cable, including the meander, extend over an angular sector of at least 30 degrees. In this way, depending on the speed of rotation of the movable assembly about its single axis of rotation, a certain duration of communication is ensured between the radiofrequency transponder rotating with the movable assembly and the reading system fixed in the transport vehicle. Of course, the larger the angular sector, the longer the communication time at a given rotation speed.

Preferably, the continuous part of the radiating part of the at least one cable is attached to the at least one wall delimiting the cavity of the transport means receiving the movable assembly.

In the case of a movable assembly rotating about a single axis of rotation, such as that comprising a tyre casing in a car, direct or indirect attachment of the continuous part of the radiating part of the bidirectional communication cable to the wheel arch is preferred. The wheel arch delimits the cavity where the vehicle-mounted assembly will be connected in use. In general, this component is non-metallic, which means that there is no shielding effect or radio interference. The propagation of radio waves between the communication cable and the transponder is enhanced by the absence of metal or conductive components between the two antennas. Lastly, the cavity naturally provides a free area for installation of the communication cable in an extremely confined space such as that of a motor vehicle.

Very preferably, the continuous part of the radiating part of the at least one cable extends at a constant radial distance from the single axis of rotation of the movable assembly.

This condition ensures reliable radiofrequency communication between the two components in the case of a passive radiofrequency transponder, such as an RFID tag, in the tyre. Indeed, it is commonly accepted to position the RFID tag at the tyre sidewall in a predominantly circumferential direction with respect to the axis of rotation of the mounted assembly. In addition, the shape of the walls delimiting the cavity for receiving the mounted assembly generally follows this geometric condition. Thus, communication between the two antennas is also optimized in terms of both duration and quality and keeping the spatial distance between the radiofrequency transponder and the continuous part of the radiating part of the communication cable constant.

Preferably, the radiofrequency transponder transmits at a sub-carrier frequency.

In these applications, the radiofrequency transponder uses the radiofrequency transmission signal it receives to transmit the response to its interrogation. This mode of operation is particularly common in passive radiofrequency transponders such as RFID tags, i.e. transponders without their own power source for transmission. These modes of communication employ various modulations, depending on whether the aim is to enhance the communication sensitivity of the bidirectional communication cable or the communication speed between the two radiofrequency devices. The modulation is characterized primarily by two variables: the number of transitions for a binary state physically, this is a change of state of the radiofrequency transponder impedance of the electronic chip of an RFID tag, for example, which induces a change in the amplitude and phase of the return signal-and the unit period for observing the transitions. To enhance the sensitivity of the communication cable, it is advisable to work on a large number of transitions for a binary state over a high unit period. For example, Miller 8 coding, applicable to UHF RFID, offers a 5 to 10 dBm gain in sensitivity. On the other hand, limiting the number of transitions to a single transition per unit period over a short unit period favours transaction throughput between the radiofrequency transponder and the bidirectional communication cable, and in fact maximizes it. FMO modulation, i.e. one transition per unit period of 7.6 us for example, increases the read rate of the bidirectional communication cable by a factor of 10 compared with Miller 8 modulation. In the case of an RFID tag, it is the reading system and in particular the electrical signal generator which controls the modulation scheme on which the radiofrequency transponder must communicate. This is not a choice of the radiofrequency transponder but an obligation placed upon it by the reading system.

Very preferably, the sub-carrier frequency of the radiofrequency transponder comprises a number of transitions of less than 5, preferably a single transition over the unit period of the sub-carrier frequency.

Very preferably, the sub-carrier frequency of the radiofrequency transponder has a unit period of less than 10 μs, preferably less than 8 μs.

Opting for short periods and few transitions favours the radiofrequency communication rate between the radiofrequency transponder and the bidirectional communication cable, i.e. the reading rate of the continuous part of the radiating part of the communication cable, which is favourable in the context of the envisaged arrangement. Indeed, the arrangement is characterized by read distances between the bidirectional communication cable and the radiofrequency transponder of less than 1 metre over a short coupling time between the two devices, due to the relative movement of the radiofrequency transponder mounted on the movable assembly, in other words owing to the speed of travel of the vehicle. The inventor has found that this mode of modulation is particularly advantageous for transport vehicles in which the continuous part of the radiating part of the communication cable is directly opposite the tyre of the movable assembly, when the vehicle is travelling at high or very high speeds.

### BRIEF DESCRIPTION OF THE DRAWINGS

The invention will be better understood upon reading the following description, which is provided solely by way of a non-limiting example and with reference to the appended figures, in which the same reference numbers in all cases denote identical parts and in which:

FIG. 1 shows a perspective view of the communication space of the radiating part of the communication cable with the movable assembly consisting of a tyre mounted and inflated on a rim which is not shown.

FIG. 2 shows an embodiment of the bidirectional communication cable of the reading system according to the invention.

FIG. 3 shows a perspective view of how the reading system is installed in a motor vehicle.

FIG. 4 shows a view in cross section of a tyre equipped with an RFID tag.

FIG. 5 shows an example of a radiofrequency transponder, in this case an RFID tag.

FIGS. 6a to 6c show an example of a continuous part of the radiating part of the cable at a movable assembly.

FIG. 7 shows a dimensional description of a meander of the bidirectional communication cable.

### DETAILED DESCRIPTION OF EMBODIMENTS

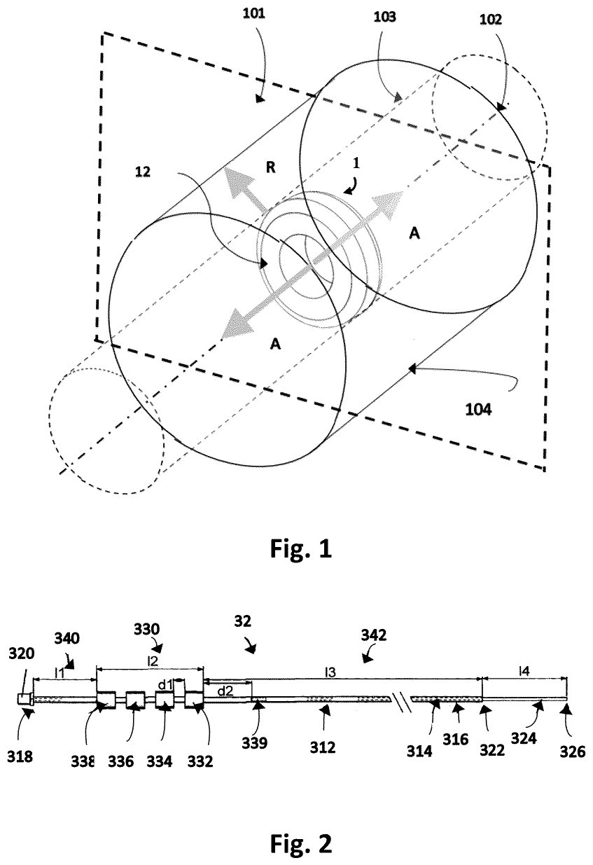

FIG. 1 shows a tyre 12 representing the deformable part of a movable assembly 1 consisting of the tyre mounted and inflated on a rim, the rim not being shown here. The tyre 12 rotates about a natural axis of rotation 102. The tyre 12 defines a median plane 101 which is perpendicular to the axis of rotation 102, separating the tyre 12 into two sub-parts which are symmetrical with respect to the median plane 101. This tyre 12 is equipped with an RFID-type radiofrequency transponder, i.e. without its own power source, used to measure the inflation pressure of the movable assembly using a pressure sensor, which corresponds to an RFID sensor-type electronic device. This tyre 12 also includes an active TPMS-type sensor mounted on the rim valve. The radial, azimuthal and axial positions of these radiofrequency devices are generally arbitrary in the movable assembly.

The tyre 12 is circumscribed in a cylinder 103 with axis of revolution 102, resting on the radially outermost position of the crown of the tyre casing in relation to the axis of rotation 102. Here, the tyre 12 is inflated but not statically loaded, and the cylinder 103 rests on a multitude of points on the crown, evenly distributed around the perimeter of the crown.

The installation space 104 of the continuous part of the radiating part of the bidirectional communication cable can then be defined as a cylinder with an axis of revolution coaxial with the axis 102, extending radially with respect to the axis 102 from the outer surface of the cylinder 103 at a distance R materialized by the grey arrow depicted in the median plane 101. This cylinder 104 is straight since it is limited by plane faces collinear to the median plane 101 located on either side of the median plane 101 at an axial distance A from the median plane 101 in the direction of the axis 102. These axial distances A are visualized by grey arrows borne by the axis 102. It is imperative to position a continuous part of the radiating part of the bidirectional communication cable preferably with a length of at least one unit of cable length, defined by the transmission frequency F0 of the reading system, in the straight cylinder 104 so that the radiofrequency devices of the movable assembly can communicate with the reading system installed on the transport means using said bidirectional communication cable.

FIG. 2 shows a bidirectional communication cable 32 in a first configuration which works perfectly well, and not exclusively, for RFID tag applications.

The cable 32 comprises an elongate bipolar coaxial conductive structure 312 with an electrically conductive inner conductor 314 and an electrically conductive sheath conductor 316 coaxially surrounding the inner conductor 314. In the illustrated example, the inner conductor 314 is cylindrical and the sheath conductor 316 is hollow and cylindrical.

Both the inner conductor 314 and the sheath conductor 316 are made of a metallic material, wherein an electrically insulating intermediate layer (e.g. plastic) is advantageously present radially between the inner conductor 314 and the sheath conductor 316 over the length of the conductive structure 312.

A first end 318 of the conductive structure 312 is provided for connecting a transmitter and/or a receiver of the reading system for an antenna signal to be transmitted using the cable 32 or an antenna signal to be received by the cable 32. The cable 32 is provided with a conventional coaxial plug 320, which coaxial plug forms an electrical connector for the inner conductor 314 and for the sheath conductor 316 at this first end 318 in a conventional manner.

In this configuration, an extension 324 of the inner conductor 314, which is integrally formed with the inner conductor 314 in the illustrated example and is therefore electrically connected to the inner conductor 314, is provided at a second, opposite end 322 of the conductive structure 312. This extension 324 extends away from the sheath conductor 316, starting from the second end 322 of the conductive structure 312, rectilinearly and coaxially to the path of the inner conductor 314 and the sheath conductor 316 directly before the second end 322.

The inner conductor extension 324 extends to a free end 326 of the inner conductor extension 324, wherein some capacitive coupling of the free end 326 or of the inner conductor extension 324 to the sheath conductor 316 exists in the region of the second end 322 thereof, depending on the length of the inner conductor extension 324.

In one transmission mode of the cable 32, i.e. if an antenna signal to be transmitted is introduced at the coaxial plug 320 of the first end 318, then this antenna signal travels through the conductive structure 312 to the end 322 and is reflected there to a greater or lesser extent, to flow back as a bound progressive wave emanating from the second end 322 along the sheath conductor 316 toward the first end 318.

For an operating mode chosen accordingly, for example with regard to the frequency and power of the injected antenna signal, it can be achieved that the cable 32 creates an alternating electromagnetic field around itself, but radiates relatively little. This cable 32 operates like a progressive-wave antenna in a “coupled mode”, so that the range of the cable 32 is well under control.

In the example shown in FIG. 2, a surface wave damping device 330 is arranged on the outer circumference of the sheath conductor 316, at a distance from the second end 322, at a point between the two ends 318 and 322. In the example shown, this device is formed by a plurality of ferrite rings 332, 334, 336 and 338, each of which surrounds the outer circumference of the sheath conductor 316.

The ferrite rings 332 to 338 are arranged at a distance from one another as seen in the longitudinal direction of the conductive structure 312, and advantageously damp said progressive waves, which rise from the second end 322 of the conductive structure 312, when these waves arrive at the location of the damping device 330.

The damping device 330 formed by the ferrite rings 332 to 338 or their arrangement location in the path of the coaxial conductive structure 312 divides the total length of the conductive structure 312 into a signal-conducting section 340 and a radiating section 342, wherein, during operation of the cable 32, the section 340 is used to conduct the antenna signal emanating from or toward the first end 318, and the section 342 is used to transmit information and/or power emanating from the cable 32 or toward the cable 32.

The number of ferrite rings and the individual distances between the ferrite rings can be adapted to the respective application or to the operating parameters of the cable 32.

It can also be provided that at least one ferrite ring, in the case of a plurality of ferrite rings, preferably at least the “first” ferrite ring closest to the second end 322, i.e. ferrite ring 332 in the illustrated example, is arranged so that it can move along the conductive structure 312.

As a result, the properties of the damping device thus formed can be influenced or adapted to the actual application.

Alternatively or in addition to the ferrite rings 332 to 338, the damping device 330 can, in deviation from the illustrated example, also comprise various damping components, such as an electrical network structure consisting of capacitive components and/or inductive and/or resistive elements, which is arranged at a relevant point along the path of the conductive structure 312 and connected on both sides to the sections 340, 342 of the conductive structure 312 leading to the first end 318 and the second end 322.

A main cable component 32 is formed by the coaxial conductive structure 312, which may be a flexible or semi-rigid cable which has an “open end” or the aforementioned inner conductor extension 324.

In the area of the inner conductor extension 324, a sheath conductor 316 forming a shield is removed to some extent in the remaining area of the conductor structure, so that a dipole antenna is created, one arm of which is formed by the inner conductor extension 324 and the other arm of which is formed by the sheath conductor 316. There are other ways of implementing capacitive coupling which are not presented here.

The surface wave damping device 330 formed here by one or more ferrite rings limits the effective antenna length for transmission/reception for the section 342.

In addition to adjusting this antenna length, the position of the damping device 330, in this case the position of the first ferrite ring 332 in particular, also influences the properties of the damping device 330 and therefore the properties of the returning progressive waves.

It is generally advantageous with regard to the desired generation of returning progressive waves if the inner conductor extension 324 has a length which, at least approximately, represents a quarter wavelength of the antenna signal concerned.

For a suitable geometry of the cable 32 and corresponding operating mode, it can be achieved that the majority of an emission signal migrates along the “signal transmitter/receiver section” 342 as sheath current, and comparatively little high-frequency energy is radiated (“coupled mode”).

The length of the inner conductor extension 324 can be chosen in such a way that a desired impedance is defined in combination with the position of the first ferrite ring 332 to achieve as high a reflection loss of the cable 32 as possible.

The length of the cable 32 and the lengths of its aforesaid individual sections can be adapted to suit the application in question.

In FIGS. 2, 11 is the length of the signal-conducting section 340, 12 is the length of the surface wave damping device 330, 13 is the length of the signal transmitter/receiver section 342 and 14 is the length of the inner conductor extension.

The distance d1 refers to the distance between the ferrite rings 332 and 334. This distance d1 is, for example, between 5 and 20 mm.

The sheath conductor 316 of the coaxial conductive structure 312 has at least one opening, this opening is drawn in dotted lines by way of example and referenced 339. The distance of the opening 339 from the damping device 330 is marked by d2 and lies in the range from 1 to 5 m. However, a plurality of openings 339 can also be arranged distributed along the length of the signal transmitter/receiver section 342 with a mutual spacing of between 0.1 and 5 times the signal wavelength.

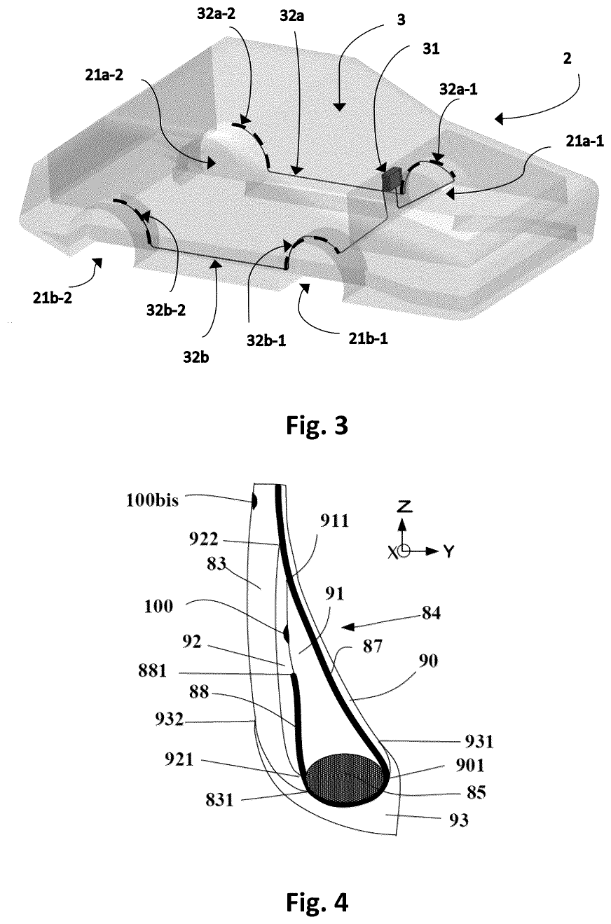

FIG. 3 shows a perspective view of how the reading system 3 is installed in a transport vehicle 2 such as a motor vehicle.

The motor vehicle 2 is represented here by a transparent volume representing the closed, equipped body, corresponding to the complete vehicle from which the axles and drive train have been removed. Nevertheless, this vehicle 2 depicts four cavities, 21a-1, 21a-2, 21b-1 and 21b-2, each designed to receive a mounted assembly of the vehicle. The mounted assembly in this case comprises radiofrequency devices of RFID tag and/or TPMS sensor type in the tyre casing.

This vehicle 2 also includes the reading system 3 enabling communication with the radiofrequency devices of the mounted assemblies. This reading system 3 comprises a first device for transmitting and reading electrical signals 31, located in the vehicle 2 at the firewall, which is a wall that is mainly vertical with respect to the ground over which the vehicle travels, delimiting the engine compartment of the vehicle, located here at the front of the vehicle 2, from the passenger compartment. This device 31 therefore comprises both the electrical signal transmitter and the electrical signal demodulator.

From this device 31, two bidirectional communication cables 32a and 32b run to the left and right sides of the vehicle 2 respectively. These communication cables are progressive-wave cables as shown in FIG. 2, and are mounted on the device 31 to form a galvanic connection. Each cable 32a, 32b runs through the structure of the vehicle 2 to reach the vicinity of at least one cavity 21a-1, 21a-2, 21b-1, 21b-2 for receiving mounted assemblies. Each cable has a signal transmission part which starts at the device 31 and then becomes radiating.

In fact, as illustrated in FIG. 3, each cable 32a, 32b reaches the vicinity of two cavities for receiving mounted assemblies each corresponding to the front axle and rear axle of the vehicle 2. At the first cavity 21a-1, the cable 32a has a continuous part 32a-1 which is located at the level of the wheel arch, describing an angular sector around the axis of the front axle of 120 degrees. This part 32 a-1 of the communication cable 32 a is located in the communication zone of the radiofrequency devices of the mounted assembly to be received in the cavity 21a-1. Thus, this part 32a-1 of the communication cable 32a will communicate with the radiofrequency devices of the mounted assembly present in the receiving cavity 21a-1. In this case, the continuous part 32a-1 of the cable is located radially outside the mounted assembly. Therefore, although not shown in FIG. 3, the continuous part 32a-1 comprises a meander, the median direction of which extends axially relative to the natural axis of rotation of the mounted assembly to be received in the cavity 21a-1, when the mounted assembly is travelling in a straight line.

However, the same cable 32a then extends toward the second receiving cavity 21a-2 located on the left side of the vehicle 2 at the rear axle. At this cavity 21a-2, the cable 32a has a continuous radiating second part 32a-2 located in the communication zone of the radiofrequency devices of the mounted assembly to be received in the cavity 21a-2. The second continuous and radiating part 32a-2 extends angularly around the axis of rotation of the rear axle over an angular sector of 90 degrees. The rear axle is not directional in this case, so the mounted assembly moves very little angularly during driving. Consequently, radiofrequency communication between the continuous and radiating part 32a-2 of the bidirectional communication cable 32a is facilitated compared with that of the part 32a-1 where the axle is directional, generating angular movement of the mounted assembly when cornering, for example. These two continuous and radiating parts, 32a-1 and 32a-2 are separate and in each case only make it possible to communicate with one mounted assembly. However, in the case of a twin-wheeled axle, as in the case of a commercial vehicle in traction mode, the continuous part 32a-2 located close to the cavity 21a-2 would enable communication with the various twin-mounted assemblies located on the same axle and on the same side of the vehicle 2.

Similarly, because of the symmetry of the motor vehicle 2, the communication cable 32b comprises a radiating part with two separate continuous parts, each communicating with a mounted assembly located on the front and rear axles respectively. As with the cable 32a located on the left side of the vehicle 2, the cable 32b has a meander in the first continuous part 32b-1. Since the continuous part 32b-1 is located radially outside the mounted assembly, the direction of the median line of the meander extends mainly in the axial direction defined by the axis of the front axle of the vehicle 2.

The total length of the bidirectional communication cable 32a and 32b does not exceed 5 meters. The length of the continuous and radiating part 32 a-1, 32 a-2, 32 b-1 and 32 b-2 is greater than 50 centimetres, corresponding to a quarter of the development of a passenger car tyre casing. This length exceeds the cable length unit for UHF radiofrequency communication at 920 MHz or 2.4 GHz.

FIG. 4 shows a detailed view of a tyre casing which forms the tyre of a movable assembly, which is represented by the mounted assembly formed of a tyre casing in an inflated state mounted on a rim. The rim represents the non-deformable part of the movable assembly. The diagram focuses on the bead 84 of the tyre casing. This figure illustrates the position of an RFID tag-type radiofrequency transponder 100 in the outer zone of the tyre casing with respect to the carcass ply 87.

The bead 84 consists of the bead wire 85, around which the carcass ply 87 is wound, with a folded portion 88 situated in the outer zone of the tyre casing. The folded part 88 of the carcass ply 87 ends with a free edge 881. A rubber mass 91, called bead wire filler, is situated radially externally and adjacent to the bead wire 85. It has a radially outer free edge 911 bearing on a face of the carcass ply 87 (more precisely on the outer calendering of the carcass ply, there is no direct contact between the cords of the carcass ply and the radiofrequency transponder 100). A second rubber mass 92, called “reinforcing filler”, is adjacent thereto. It has two free edges. The first free edge 921 is situated radially internally and bears on the folded part 88 of the carcass ply. The other free edge 922 is situated radially externally and ends on the face of the carcass ply 87. Lastly, the sidewall 83 covers both the reinforcing filler 92 and the carcass ply 87. The sidewall has a free edge 831 situated radially internally and ending on the folded part 88 of the carcass ply.

The airtight inner liner 90, which is adjacent to the carcass ply 87 in this configuration, is located on the inner zone of the tyre casing. It ends with a free edge 901 adjacent to the carcass ply 87. Lastly, a protective bead 93 protects the carcass ply 87 and the radially inner ends 901, 921 and 831 of the airtight inner liner 90, of the reinforcing filling rubber 92 and of the sidewall 83, respectively. The outer face of this protective bead 93 is adapted to be in direct contact with the rim flange when the tyre casing is mounted on the wheel. This protective bead 93 has two radially outer free edges. The first free edge 931 is situated in the inner zone of the tyre casing 1. The second free edge 932 is situated in the outer zone of the tyre casing 1.

The bead 84 of this tyre casing is equipped with two RFID tags 100 and 100bis that are situated in the outer zone of the tyre casing. The first radiofrequency transponder 100, having been encapsulated beforehand in an electrically insulating encapsulating rubber, is positioned on the outer face of the bead wire filler 91. It is positioned at a distance of 20 millimetres from the free edge 881 of the folded part 88 of the carcass ply that constitutes a mechanical singularity. This position ensures a zone of mechanical stability for the electronic element 100 that is beneficial to the mechanical endurance thereof. In addition, embedding it within the structure of the mechanical casing gives it good protection against mechanical attacks coming from outside the tyre.

The second radiofrequency transponder 100a, having been encapsulated beforehand in an electrically insulating encapsulating rubber compatible with or similar to the material of the sidewall 83, is positioned on the outer face of the sidewall. The material similarity between the sidewall 83 and the encapsulating rubber ensures that the RFID tag 100bis is installed inside and at the periphery of the sidewall 83 during the curing process. The RFID tag 100bis is simply placed on the uncured outer face of the sidewall 83 during the production of the tyre casing. Pressurizing the green body in the curing mould ensures the positioning of the RFID tag 100bis in the cured state, as shown. This RFID transponder 100bis is situated far from any free edge of a rubber component of the tyre casing. In particular, it is at a distance from the free edge 932 of the protective bead, from the free edge 881 of the carcass ply and from the free edges 911 and 922 of the filling rubbers. Its position at the upper part of the bead ensures improved communication performance with an external radiofrequency reader.

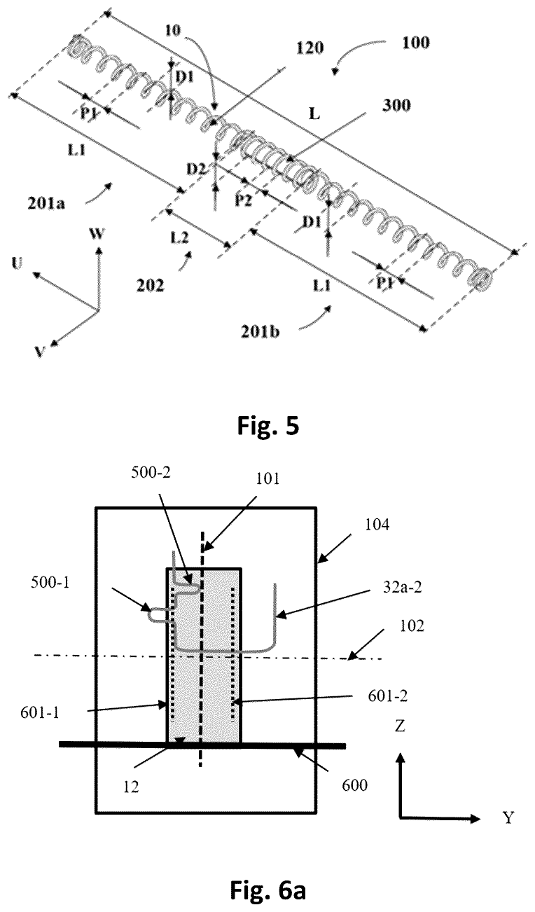

FIG. 5 is an illustration of a radiofrequency transponder 100 operating in the frequency range between 860 and 960 MHz, this transponder being intended to be incorporated into a tyre casing via an identification patch made of elastomeric material. To enhance the radiocommunication performance and the physical integrity of the radiofrequency transponder 100 within the tyre casing, it will be preferable to place the axis of revolution of the radiating antenna 10 parallel to the direction U, i.e. in a direction perpendicular to the threads of the carcass ply of the tyre casing of radial structure, in particular if the threads are made of metal.

The radiofrequency transponder 100 here comprises a radiating antenna 10 and an electronic portion located inside the radiating antenna 10. The electronic portion comprises an electronic chip connected to a printed circuit board. A primary antenna consisting of a conductive wire is connected to the printed circuit board. The opposite side of the printed circuit board to the primary antenna comprises a meander-shaped galvanic circuit. Lastly, the diameter of the cylinder circumscribing the primary antenna is 0.8 millimetres. Both the primary antenna and the galvanic circuit on the opposite side of the printed circuit board allow the impedance of the primary antenna to be matched to that of the circuit board.

The circuit board thus formed is embedded in a mass 300 of epoxy resin, ensuring the mechanical reliability of the electronic components and the electrical insulation of the circuit board. The cylinder circumscribing the stiff mass 300 has a diameter of 1.15 millimetres and a length of 6 millimetres.

The length L of the radiating antenna 10 is here 45 millimetres and corresponds to one half-wavelength of radioelectric waves at a frequency of 915 MHz in a medium of relative dielectric permittivity of about equal to 5. The radiating antenna 10 is produced using a steel wire 120 of 0.225 millimetre diameter the surface of which is coated with a layer of brass. This steel wire 120 is the wire strand of the radiating antenna of the radiofrequency transponder 100 defining the first longitudinal axis of the radiofrequency transponder 100.

In this case, the radiating antenna 10 is divided into two main regions. The first region 201 corresponds to the section of the radiating antenna that is not located plumb with the electronic portion. It comprises two sub-regions 201a and 201b flanking on either side the stiff and electrically insulating mass 300.

Each sub-region 201a, 201b has a length L1 of 19 millimetres and comprises 12 circular turns with a constant winding diameter D1 of 1.275 millimetres. This defines inside and outside diameters of 1.05 and 1.5 millimetres, respectively. The helix pitch P1 of the circular turns is 1.55 millimetres. Thus, the ratio of the helix pitch P1 to the winding diameter D1 of the turns is 1.21. The axially outer ends of each sub-region 201a and 201b end in two adjoining turns. Thus, the high ratio ensures the efficacy of the radioelectric properties of the radiating antenna 10 is maximized in this region 201. In addition, the contact between the turns located outermost on the radiating antenna 10 prevents the helical springs from becoming interlaced with one another during handling of the radiofrequency transponders. As most of the turns of the first region 201 of the radiating antenna 10 have a ratio higher than 0.8, the radioelectric performance of the radiofrequency transponder 100 is clearly improved.

In the second region 202 of the radiating antenna 10, which corresponds to the section of the radiating antenna 10 located plumb with the electronic portion, the radiating antenna 10 has a length of 7 millimetres. The helical spring has a constant helix pitch P2 of 1 millimetre and a constant winding diameter D2 of 1.575 millimetres. Thus, the inside diameter of the helical spring of the second region of the radiating antenna is 1.35 millimetres. This makes it possible to have a ratio of the pitch to the winding diameter that is constant of the order of 0.63. This ratio allows the inductance of the second region 202 of the radiating antenna 10 to be maximized with respect to the first region 201, this allowing the efficacy of the electromagnetic coupling to the electronic portion to be improved.

In this particular case, in the first region 201 the inside diameter of the radiating antenna 10, which is equal to 1.05 millimetres, is smaller than the diameter, equal to 1.15 millimetres, of the mass 300 as represented by the cylinder circumscribing the electronic portion. Thus, the sub-regions 201a and 201b of the first region 201 of the radiating antenna 10 form mechanical stops that limit the axial movement of the mass 300 inside the radiating antenna 10. The electronic portion is, in a first embodiment, installed by slipping the stiff and insulating mass 300 into the radiating antenna 10.

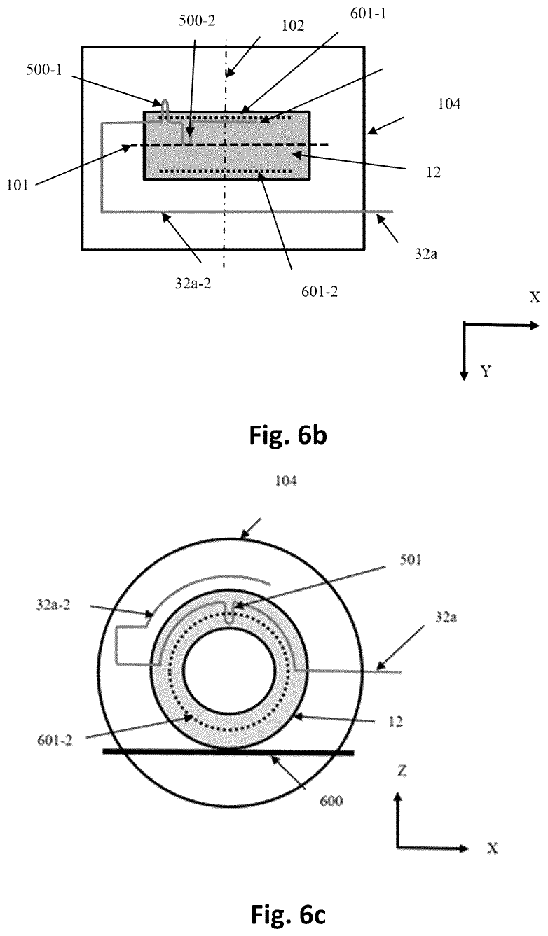

FIGS. 6a, 6b et 6c are various two-dimensional views of the communication zone 104 of the radiofrequency transponders of the mounted assembly, which in this example are mainly attached to the tyre 12, and the reading system mounted on the transport vehicle. The tyre 12 is mounted on a rim, not shown. The movable assembly thus formed defines a natural axis of rotation 102 and a median plane 101. This movable assembly is mounted on the axle of the vehicle. The movable assembly located at the rear right-hand side of the transport vehicle is shown here. The vehicle can move over the ground 600 by means of the tyre 12. This tyre 12 here comprises two radiofrequency transponders each located in a side of the tyre 12, in the lower zone. Thus, one of the sides is located inside the vehicle while the other opens to the outside of the vehicle in the absence of any bodywork element of the transport vehicle obstructing this opening. During the rotational movement of the movable assembly, the radiofrequency transponders describe a closed loop 601-1, respectively 601-2, which is similar to a circle with an axis of rotation corresponding to the natural axis of rotation 102 of the tyre 12.

FIG. 6a is a view in the plane YZ of the motor vehicle, which corresponds to a front view of the movable assembly. FIG. 6b corresponds to a view in the plane XY, which corresponds to a top view of the movable assembly, and FIG. 6c shows a view in the plane XZ, which corresponds to a side face of the movable assembly. The radiofrequency communication cylinder 104 is shown in the three figures between the radiofrequency transponders of the movable assembly and the reading system represented by the radiating part of the bidirectional communication cable 32a. When the communication cable 32a enters the communication volume 104, this cable becomes the continuous part 32a-2 of the radiating part of the cable 32a for the movable assembly located at the rear right-hand side of the vehicle. The fact that the cable 32a, once it has entered the volume 104, does not emerge again from the volume 104 indicates that there is a single continuous part 32a-2 of the radiating part of the cable 32a associated with this movable assembly. The continuous part 32a-2 first runs along the inner side of the tyre 12 relative to the vehicle, describing part of a first circle centred on the natural axis of rotation 102 of the movable assembly. Then, after a bend in this cable 32a, it moves to the other side of the median plane 101 of the movable assembly, in the direction Y of the vehicle. Finally, it partially describes a second circle, again centred on the natural axis of rotation 102 of the movable assembly, before the cable ends at a tip which is located in the volume 104 in this specific case. This tip could be located outside the volume delimited by the cylinder 104.

The first circle described by the continuous part 32a-2 is located axially outside the movable assembly. In this case, the first circle has a radius which is smaller than the maximum radius of the movable assembly; it could be greater. On this arc of a circle described by the continuous part 32a-2 of the communication cable, there is a meander 501 extending perpendicularly to the arc of a circle, in other words radially in the reference frame of the movable assembly. The surface delimited by the meander extends radially internally to the first circle such that it intercepts the loop 601-2 described by the movement of the radiofrequency transponder present on the inner side of the tyre 12. This loop is shown as a circle in dotted lines in FIG. 6c. For an RFID tag operating at the UHF frequency of 920 MHz, the length of the radiofrequency antenna of the RFID tag is of the order of 5 centimetres when the RFID tag is embedded in the structure of the tyre. Generally, this radio tag is oriented primarily circumferentially. The meander 601-2 has a distance separating the outward and return paths, here approximately 8 centimetres, which allows for improved radiofrequency communication between the meander 601-2 and the antenna of the RFID tag since the entire radiating antenna of the radio tag is immersed in the constant electric field of the meander at a given time.

The second circle described by the continuous part 32a-2 of the communication cable 32a is located radially outside the tyre 12 relative to the axis of rotation 102. In the example illustrated by FIG. 6 of this movable assembly, the cable 32a on the outer side of the vehicle is mainly located axially inside the tyre 12, with the exception of the meander 500-1 extending axially externally relative to the tyre 12. To be specific, a part of this meander 500-1 is then located axially outside the tyre 12 as shown in FIG. 6a and FIG. 6b. However, the loop 601-1 described by the pseudo-periodic movement of the radiofrequency transponder of the tyre is located axially close to the second circle of the communication cable 32a, which optimizes radiofrequency communication between the two antennas. The meander 500-2 would in this case make it possible to interrogate another radiofrequency transponder mounted on a movable assembly having a smaller width in the axial direction, or located plumb with the crown of the tyre 12, this crown capping the tyre 12 radially and externally.

Such a continuous part 32a-2 of the radiating part of the communication cable 32a, rigidly secured to the transport vehicle, makes it possible to communicate by radio waves with radiofrequency transponders mounted on the movable assembly, in particular the tyre 12. This radiofrequency communication is operational whether the radiofrequency transponders are located on one or other side of the tyre 12 or in line with the crown of the tyre 12 and moreover, whatever the dimension, in particular the width, of the movable assembly fitted to the transport vehicle. However, this is not necessarily the only configuration for achieving this radiofrequency communication objective but merely an illustrative example.

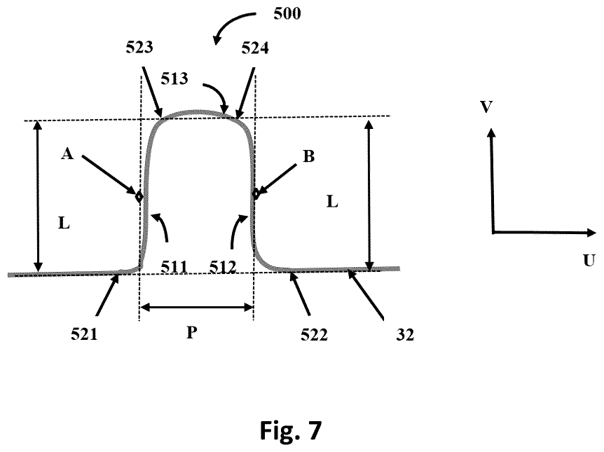

FIG. 7 is an example of a meander 500 on the continuous part of the radiating part of a bidirectional communication cable 32. This meander 500 is defined in an orthonormal plane UV associated with the meander. The axis U defines the tangent of the communication cable 32 located just upstream and/or downstream of the meander 500; if these two directions are not parallel, the median direction will be taken. The meander 500 follows an outward path 511 and a return path 512 which are connected to one another by a segment 513 at their second end. The first end of the outward path 511, respectively of the return path 512, is connected to the communication cable 32 located downstream or upstream of the meander 500. The change of direction between the communication cable 32 on the one hand and the outward path 511 or return path 512 of the meander 500 on the other hand is made possible by the flexible nature of the communication cable 32 which allows a more or less pronounced curvature of the cable 32. Naturally, this same change of direction also occurs between, on the one hand, the outward path 511, or return path 512, of the meander 500 and the segment 513. The flexibility of the cable also allows this change of direction through the bending potential of the communication cable 32.

This meander 500 is defined on the one hand by the average spacing between the outward path 511 and the return path 512, denoted “P”, and the curvilinear length L of the meander 500. The curvilinear length L of the meander 500 is evaluated between two points of the cable 32, the starting point 521 and the arrival point 522 of the meander 500. Each of the points 521 and 522 corresponds to the change in curvature of the cable 32 relative to the direction of the cable 32 located downstream, respectively upstream, of the meander 500, i.e. the direction of the vector U.

Then, the length “L” of the outward path 511, or of the return path 512, of the meander 500 is defined as the distance in the direction V, perpendicular to the direction U of the cable, between the starting point 521 of the outward path 511, respectively the arrival point 522 of the return path 512, and the second end 523 of the outward path 511, respectively the second end 524 of the return path 512. This second end 523 or 524 is determined by two conditions. The first condition is that it is the highest coordinate in the direction V of a point of the communication cable 32 from the first end 521 of the outward path 511, respectively the first end 522 of the return path 512. Note that the origin of the axis V is defined at the point 521, respectively 522. The second condition is that the tangent of the point of the communication cable 32 at this second end 523 or 524 has its largest component carried by the direction V. Lastly, the segment 513 is delimited by the second ends 523 and 524 of the outward path 511 and the return path 512. Preferably, the curvilinear abscissa of the outward path 511 and the return path 512 is less than the half-wavelength L0 associated with the communication frequency F0 of the reading system.

Finally, the average spacing “P” of the meander is determined by taking the distance in the direction U between the outward path 511 and the return path 512. The position in the direction U of the outward path 511, respectively the return path 512, corresponds to the average value UA, respectively UB, of the coordinates of the points of the outward path 511, respectively the return path 512, in the direction U with a homogeneous distribution of the points along the cable 32. The point A characteristic of the outward path 511, respectively the point B characteristic of the return path 512, the coordinates of which are UA and VA, respectively UB and VB, in the reference frame UV associated with the meander 500, are shown, using a diamond, in FIG. 7.

1.-15. (canceled)

16. A transport vehicle comprising:
a radiofrequency transponder reading system; and
at least one movable assembly, capable of ensuring movement of the transport vehicle relative to a ground over which the transport vehicle is travelling, comprising a tire set in motion about an axis of rotation,
free movement of the at least one movable assembly taking place in a predominantly two-dimensional plane in a cylindrical reference frame associated with the at least one movable assembly, an axial direction of which is a direction of the axis of rotation,
the tire defining a median plane which is perpendicular to the axis of rotation,
the at least one movable assembly being equipped with a radiofrequency transponder,
the radiofrequency transponder reading system comprising:
a generator of electrical signals transmitting at a frequency F0 included in an ultra-high frequency band, coupled to a demodulator of electrical signals adapted to a frequency band around F0, mounted on the transport vehicle;
at least one bidirectional communication cable, partially flexible, comprising a conductive core covered with a first dielectric element, the first dielectric element covered with a conductive assembly, having one end galvanically connected to the radiofrequency transponder reading system, having at a free end a means for capacitive coupling between the conductive core and the conductive assembly via a second dielectric element, adapted to the frequency band of the radiofrequency transponder reading system,
the at least one bidirectional communication cable, being rigidly secured to the transport vehicle and external to the at least one movable assembly, comprising a radiating part,
wherein a distance of a radial projection of a first continuous part of the radiating part of the at least one bidirectional communication cable on a cylinder, with an axis of revolution coaxial with the axis of rotation, circumscribing the tire, is less than or equal to 1 meter,
wherein a distance of an axial projection, in the direction of the axis of rotation, of the first continuous part of the radiating part of the at least one bidirectional communication cable on the median plane of the tire is less than 2 meters,
wherein the first continuous part of the radiating part of the at least one bidirectional communication cable comprises at least one meander comprising an outward path and a return path spaced apart from one another by a distance P, each outward path and return path extending over a length L,
wherein a curvilinear length of the at least one meander is between 0.7 and 1.3 times a wavelength L0 defined by the communication frequency F0, and
wherein the distance P is less than a third of the wavelength L0.

17. The transport vehicle according to claim 16, wherein the radiating part of the at least one bidirectional communication cable comprises at least one second continuous part that is separate from the first continuous part, a distance of a radial projection of the at least one second continuous part of the radiating part of the at least one bidirectional communication cable on a cylinder, of axis of revolution coaxial with the axis of rotation of at least one second movable assembly, circumscribing the tire of the at least one second movable assembly, is less than or equal to 1 meter, and a distance of an axial projection, in the direction of the axis of rotation of the at least one second movable assembly, of the at least one second continuous part of the radiating part of the at least one cable on the median plane of the tire of the at least one second movable assembly is less than 2 meters.

18. The transport vehicle according to claim 17, wherein the at least one second continuous part of the radiating part of the at least one bidirectional communication cable comprises at least one meander comprising an outward path and a return path spaced apart from one another by the distance P, each outward path and return path extending over the length L, a curvilinear length of the at least one meander is between 0.7 and 1.3 times the wavelength L0,and the distance P is less than a third of the wavelength L0.

19. The transport vehicle according to claim 16, wherein the radiating part of the at least one bidirectional communication cable comprises at most five meanders.

20. The transport vehicle according to claim 16, wherein the radiofrequency transponder associated with the at least one movable assembly comprises a radiofrequency antenna comprising at least one wire strand defining a first longitudinal axis, each meander of the first continuous part of the radiating part of the at least one bidirectional communication cable defining a median line defined by the direction of the length L of the at least one meander, the angle formed by direction vectors of the first longitudinal axis and the median line being between 60 and 120 degrees over at least part of a closed path described by the at least one movable assembly.

21. The transport vehicle according to claim 20, wherein, with the at least one movable assembly being capable of describing a rotational movement about a single axis of rotation defining a cylindrical reference frame about the axis of rotation, the first longitudinal axis of the radiofrequency antenna of the radiofrequency transponder associated with the at least one movable assembly having a main component oriented circumferentially in the cylindrical reference frame, and the at least one meander associated with the first continuous part of the radiating part of the at least one bidirectional communication cable being arranged radially outside the at least one movable assembly relative to the axis of rotation, the median line of the at least one meander has a main component oriented axially in the cylindrical reference frame of the at least one movable assembly.

22. The transport vehicle according to claim 21, wherein, with the radiofrequency antenna of the radiofrequency transponder associated with the at least one movable assembly and the at least one meander associated with the first continuous part of the radiating part of the at least one bidirectional communication cable projecting in the same circumferential plane, projection of the antenna is entirely included in the projection of the at least one meander.

23. The transport vehicle according to claim 20, wherein, with the at least one movable assembly being capable of describing a rotational movement about a single axis of rotation defining a cylindrical reference frame about the axis of rotation, the first longitudinal axis of the radiofrequency antenna of the radiofrequency transponder associated with the at least one movable assembly having a main component oriented circumferentially in the cylindrical reference frame, and the at least one meander associated with the first continuous part of the radiating part of the at least one bidirectional communication cable being arranged axially outside and radially inside the at least one movable assembly relative to the axis of rotation, the median line of the at least one meander has a main component oriented radially in the cylindrical reference frame of the at least one movable assembly.

24. The transport vehicle according to claim 23, wherein, with the radiofrequency antenna of the radiofrequency transponder associated with the at least one movable assembly and the at least one meander associated with the first continuous part of the radiating part of the cable projecting in the same axial plane, the projection of the antenna is entirely included in the projection of the at least one meander.

25. The transport vehicle according to claim 16, wherein the radiofrequency transponder comprises an RFID tag.

26. The transport vehicle according to claim 16, wherein, with the at least one movable assembly being capable of describing a rotational movement about an axis of rotation, each continuous part of the at least one bidirectional communication cable describes an angular sector about the axis of rotation which is at least greater than 30 degrees.

27. The transport vehicle according to claim 16, wherein the continuous part of the radiating part of the at least one bidirectional communication cable is attached to at least one wall delimiting a cavity of the transport vehicle receiving the at least one movable assembly.

28. The transport vehicle according to claim 26, wherein the first continuous part of the radiating part of the at least one cable extends at a constant radial distance from the axis of rotation of the at least one movable assembly.

29. The transport vehicle according to claim 16, wherein the radiofrequency transponder transmits at a sub-carrier frequency.

30. The transport vehicle according to claim 29, wherein the sub-carrier frequency of the radiofrequency transponder comprises a number of transitions of less than 5 over a unit period of the sub-carrier frequency.
